(19) United States
(12) Patent Application Publication
(10) Pub. No.: US 2026/0084357 A1
(43) Pub. Date: Mar. 26, 2026

(54) INJECTION MOLDING DEVICE AND INJECTION MOLDING METHOD

(71) Applicant: SEIKO EPSON CORPORATION, Tokyo (JP)

(72) Inventor: Shin HIDO, OMACHI-SHI (JP)

(21) Appl. No.: 19/338,597

(22) Filed: Sep. 24, 2025

(30) Foreign Application Priority Data
Sep. 26, 2024 (JP) 2024-167066

(51) Int. Cl. B29C 45/78; B29C 45/27; B29C 45/74

(52) U.S. Cl. CPC B29C 45/78; B29C 45/2737; B29C 45/74; B29C 2945/76525; B29C 2945/76531; B29C 2945/76688; B29C 2945/76859

(57) ABSTRACT

An injection molding device injects a plasticized material into a mold and performs injection molding of a molded product, the injection molding device including: a plasticizing unit configured to plasticize a material and generate the plasticized material; a first hot runner including a first flow path that communicates with the plasticizing unit and through which the plasticized material flows, a first nozzle portion that communicates with the first flow path and injects the plasticized material, and a first heater that heats the plasticized material in the first flow path; and a control unit configured to control injection of the plasticized material, in which the first nozzle portion is made of a metal material, and the control unit includes a first temperature control unit that is electrically coupled to the first heater and controls a temperature of the first heater and a second temperature control unit that is electrically coupled to the first nozzle portion and controls a temperature of the first nozzle portion by supplying a current to the first nozzle portion.

The present application is based on, and claims priority from JP Application Serial Number 2024-167066, filed Sep. 26, 2024, the disclosure of which is hereby incorporated by reference herein in its entirety.

### BACKGROUND

### 1. Technical Field

The present disclosure relates to an injection molding device and an injection molding method.

### 2. Related Art

JP-A-2020-11488 discloses an injection molding device including a hot runner. The hot runner includes a first heater disposed around a nozzle portion and a second heater disposed farther from the nozzle portion than the first heater.

JP-A-2020-11488 is an example of the related art.

When the hot runner has a reduced size, it is difficult to dispose a heater around a small member such as the nozzle portion. When no heater is disposed around the nozzle portion, there is a problem that the nozzle portion cannot be sufficiently heated and a plasticized material during injection has decreased fluidity.

### SUMMARY

According to a first aspect of the present disclosure, an injection molding device is provided. The injection molding device injects a plasticized material into a mold and performs injection molding of a molded product, the injection molding device including: a plasticizing unit configured to plasticize a material and generate the plasticized material; a first hot runner including a first flow path that communicates with the plasticizing unit and through which the plasticized material flows, a first nozzle portion that communicates with the first flow path and injects the plasticized material, and a first heater that heats the plasticized material in the first flow path; and a control unit configured to control injection of the plasticized material, in which the first nozzle portion is made of a metal material, and the control unit includes a first temperature control unit that is electrically coupled to the first heater and controls a temperature of the first heater and a second temperature control unit that is electrically coupled to the first nozzle portion and controls a temperature of the first nozzle portion by supplying a current to the first nozzle portion.

According to a second aspect of the present disclosure, an injection molding method is provided. The injection molding method performs injection molding of a molded product by an injection molding device, the injection molding device including a plasticizing unit configured to plasticize a material and generate a plasticized material and a first hot runner including a first flow path that communicates with the plasticizing unit and through which the plasticized material flows, a first nozzle portion that communicates with the first flow path and injects the plasticized material, and a first heater that heats the plasticized material in the first flow path, the first nozzle portion being made of a metal material, the injection molding method including: a first step of controlling a temperature of the first heater; and a second step of controlling a temperature of the first nozzle portion by supplying a current to the first nozzle portion.

### BRIEF DESCRIPTION OF THE DRAWINGS

FIG. 1 shows a schematic configuration of an injection molding device.

FIG. 2 is a sectional view showing schematic configurations of an injection unit and a mold clamping unit.

FIG. 3 is a perspective view showing a schematic configuration of a flat screw.

FIG. 4 is a schematic plan view of a barrel.

FIG. 5 is an enlarged view showing a range AR in FIG. 2.

FIG. 6 shows a schematic configuration of a first control unit.

FIG. 7 is a flowchart of a temperature control process.

FIG. 8 is a time chart showing temperature control of an injection nozzle portion by a second temperature control unit.

FIG. 9 is a time chart showing the temperature control of the injection nozzle portion by the second temperature control unit according to a second embodiment.

FIG. 10 shows a schematic configuration of an injection molding device according to a third embodiment.

FIG. 11 shows schematic configurations of a hot runner control unit and a first control unit.

FIG. 12 shows a schematic configuration of the injection molding device according to the third embodiment.

FIG. 13 is a flowchart of a temperature control process according to the third embodiment.

FIG. 14 is a time chart showing temperature control of a first nozzle portion and a second nozzle portion by the second temperature control unit according to the third embodiment.

### DESCRIPTION OF EMBODIMENTS

### A. First Embodiment

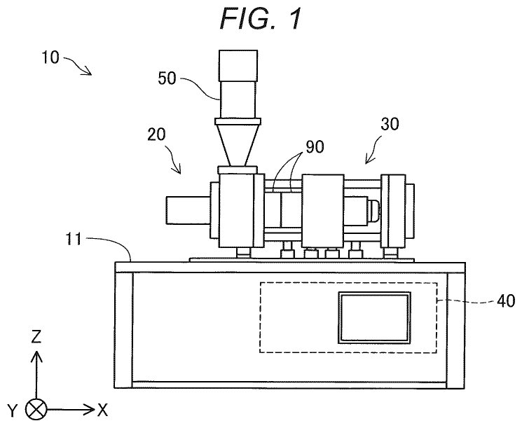

FIG. 1 shows a schematic configuration of an injection molding device 10. FIG. 1 shows arrows indicating X, Y, and Z directions perpendicular to one another. The X direction and the Y direction are parallel to a horizontal plane. The Z direction is parallel to a vertical direction. The X, Y, and Z directions in FIG. 1 and the X, Y, and Z directions in the other figures indicate the same directions. When specifying an orientation, a positive or negative sign is used together with description of a direction, a positive direction which is a direction pointed by an arrow is defined as “+”, and a negative direction which is a direction opposite to the direction pointed by the arrow as “−”.

The injection molding device 10 includes an injection unit 20, a mold clamping unit 30, and a first control unit 40. The injection molding device 10 performs injection molding of a molded product using a mold 90 installed to the mold clamping unit 30. In the embodiment, the mold 90 made of metal is installed to the mold clamping unit 30. The mold 90 installed to the mold clamping unit 30 is not limited to being made of a metal, and may also be made of resin or ceramic. The mold 90 made of metal is referred to as a metallic mold. The mold 90 is also simply referred to as a mold. The injection unit 20 and the mold clamping unit 30 are fixed on a base 11. The first control unit 40 is accommodated in the base 11.

To the injection unit 20, a hopper 50 for loading a material for a molded product is coupled. An example of the material for the molded product includes a thermoplastic resin formed in a pellet shape. Examples of the thermoplastic resin include acrylonitrile butadiene styrene (ABS), polycarbonate (PC), polyacetal (POM), polypropylene (PP), and polybutylene terephthalate (PBT). The material for the molded product may contain metal and ceramic in addition to the thermoplastic resin. Supply of the material to the injection unit 20 is not limited to supply from the hopper 50 and may be carried out, for example, by a tube through which the material is pumped.

The injection unit 20 plasticizes at least a part of the material supplied from the hopper 50, generates a plasticized material, and injects the generated plasticized material into the mold 90. In the present specification, “plasticizing” refers to a concept including melting and means changing from a solid state to a fluid state. Specifically, in a case of a material in which glass transition occurs, plasticizing refers to setting a temperature of the material to a glass transition point or higher. In a case of a material in which glass transition does not occur, plasticizing means setting a temperature of the material to a melting point or higher.

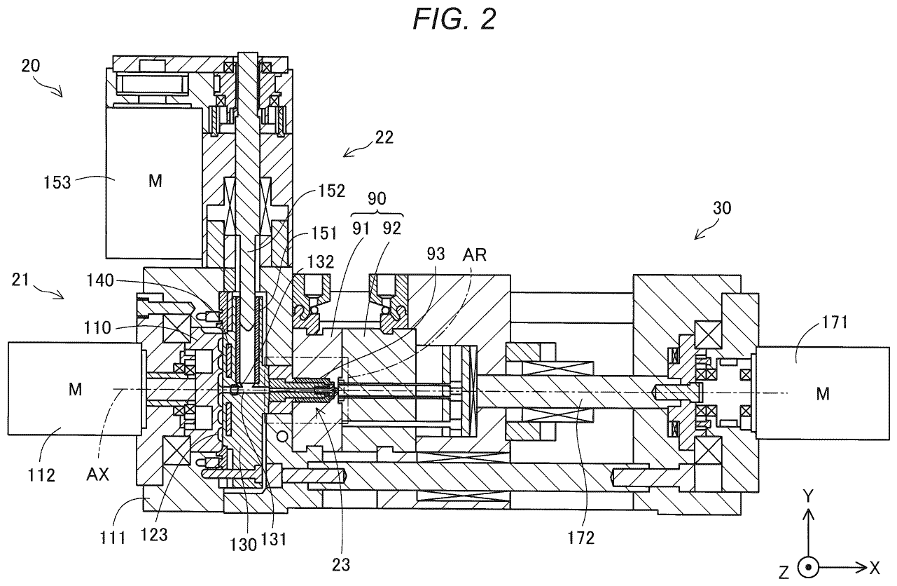

FIG. 2 is a sectional view showing schematic configurations of the injection unit 20 and the mold clamping unit 30. The injection unit 20 includes a plasticizing unit 21, a suction and feed unit 22, and an injection portion 23.

The plasticizing unit 21 plasticizes at least a part of the material supplied from the hopper 50 and generates the plasticized material. The plasticizing unit 21 includes a flat screw 110, a barrel 130, and a barrel heater 140.

The flat screw 110 is accommodated in a screw case 111. The flat screw 110 is also referred to as a rotor or simply a screw. The flat screw 110 is disposed such that an axis thereof coincides with an axis AX of an in-injection-portion flow path to be described later. A direction along the axis AX is the X direction. The flat screw 110 is rotationally driven about the axis AX inside the screw case 111 by a drive motor 112. The barrel 130 is formed with, in a center thereof, a communication hole 131 that penetrates the barrel 130 in the X direction. The communication hole 131 constitutes a part of a flow path through which the plasticized material flows. The communication hole 131 has an axis thereof coinciding with the axis AX. To the communication hole 131, an injection cylinder 151 is coupled, which will be described later. The communication hole 131 is provided with a check valve 132 upstream of the injection cylinder 151. The barrel heater 140 is embedded in the barrel 130. Rotation of the flat screw 110 by the drive motor 112 as well as heating by the barrel heater 140 are controlled by the first control unit 40.

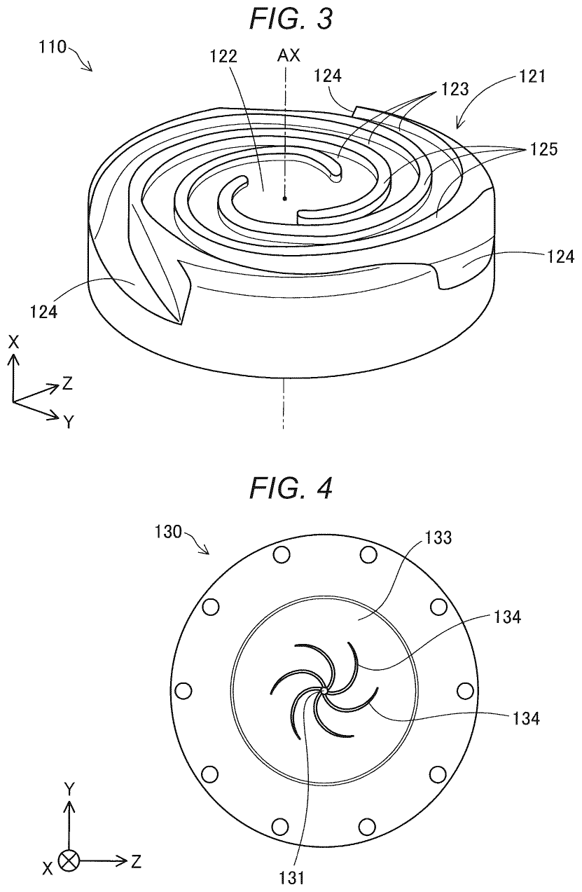

FIG. 3 is a perspective view showing a schematic configuration of the flat screw 110. The flat screw 110 has a substantially columnar shape whose height in a direction along a central axis thereof is smaller than a diameter. The flat screw 110 is formed with, on a groove forming surface 121 thereof which faces the barrel 130, spiral grooves 123 that center on a central portion 122. The grooves 123 communicate with a material inlet 124 formed in a side surface of the flat screw 110. The material supplied from the hopper 50 is supplied to the grooves 123 through the material inlet 124. The grooves 123 are defined by being separated by convex ridge portions 125. FIG. 3 shows an example in which three grooves 123 are provided, and the number of grooves 123 may be one or two or more. The grooves 123 are not limited to spirals and may have a helical shape or an involute curve shape, and may also have a shape extending to draw an arc from the central portion 122 toward an outer circumference.

FIG. 4 is a schematic plan view showing the barrel 130. The barrel 130 has a counter surface 133 that faces the groove forming surface 121 of the flat screw 110. The counter surface 133 is formed with a communication hole 131 in a center thereof. The counter surface 133 is formed with a plurality of guide grooves 134 that are coupled to the communication hole 131 and extend in a spiral shape from the communication hole 131 toward an outer circumference. The material supplied to the grooves 123 of the flat screw 110 is plasticized between the flat screw 110 and the barrel 130 by the rotation of the flat screw 110 and the heating by the barrel heater 140, flows along the grooves 123 and the guide grooves 134 by the rotation of the flat screw 110, and is guided to the central portion 122 of the flat screw 110. The material flowing into the central portion 122 flows out to the suction and feed unit 22 from the communication hole 131 formed in the center of the barrel 130. The barrel 130 may not be provided with the guide grooves 134. The guide grooves 134 may not be coupled to the communication hole 131.

As shown in FIG. 2, the suction and feed unit 22 includes the injection cylinder 151, a plunger 152, and a plunger drive unit 153. The suction and feed unit 22 controls an injection amount, injection speed, and injection pressure of the plasticized material from the injection portion 23 under the control of the first control unit 40. The injection cylinder 151 is a substantially cylindrical member coupled to the communication hole 131 of the barrel 130 and is provided with the plunger 152 therein. The plunger 152 slides inside the injection cylinder 151, and pumps the plasticized material in the injection cylinder 151 to the injection portion 23. The plunger 152 is driven by the plunger drive unit 153 implemented by a motor.

The injection portion 23 injects the plasticized material pumped from the suction and feed unit 22 into the mold 90. The injection portion 23 includes a hot runner having an open gate system, and guides the plasticized material in a heated state to the mold 90. In the embodiment, the injection portion 23 is also referred to as a first hot runner.

The mold 90 includes a fixed mold 91 and a movable mold 92. The movable mold 92 is mounted on the mold clamping unit 30 in a manner of facing the fixed mold 91. The fixed mold 91 is a mold whose position is fixed in a mold clamping operation. The movable mold 92 is a mold that is moved relative to the fixed mold 91 in the mold clamping operation. The movable mold 92 is moved in a mold clamping direction relative to the fixed mold 91 by the mold clamping unit 30. In the embodiment, the mold clamping direction is a-X direction.

The mold clamping unit 30 includes a mold drive unit 171 and has a function of opening and closing the movable mold 92 and the fixed mold 91. Under the control of the first control unit 40, the mold clamping unit 30 drives the mold drive unit 171, which is implemented by a motor, to rotate a ball screw 172 and move the movable mold 92, which is coupled to the ball screw 172, relative to the fixed mold 91, thereby opening and closing the mold 90. When the mold 90 is clamped and the fixed mold 91 and the movable mold 92 are brought into contact, a cavity that defines a shape of the molded product is formed between the fixed mold 91 and the movable mold 92.

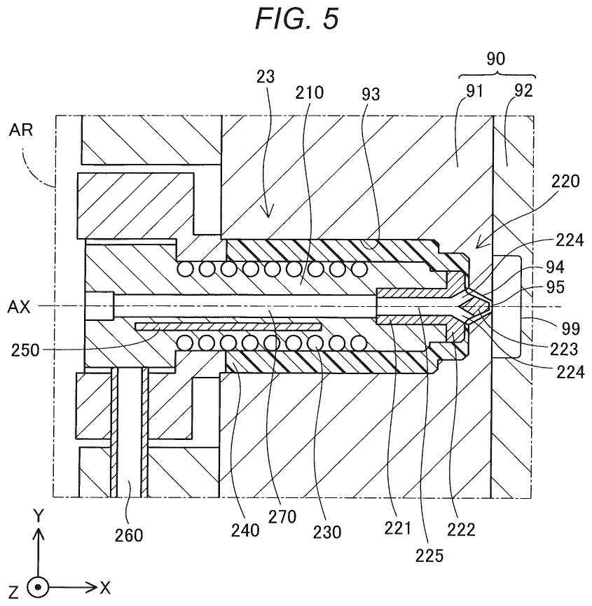

FIG. 5 is an enlarged view showing a range AR in FIG. 2. The fixed mold 91 is formed with a hot runner attachment hole 93 that penetrates the fixed mold 91 in the X direction. The injection portion 23 is disposed in the hot runner attachment hole 93. The hot runner attachment hole 93 is formed such that an inner diameter thereof is reduced stepwise in order from a plasticizing unit 21 side. In the embodiment, the plasticizing unit 21 side is a-X direction side. The hot runner attachment hole 93 has, on an opposite side from the plasticizing unit 21 side, an end portion 94 that has a substantially conical shape and whose inner diameter gradually decreases. The end portion 94 has a tip end side thereof functioning as a gate opening 95 into which the plasticized material flows. The gate opening 95 is a substantially circular hole. The gate opening 95 has an open gate structure of a ring gate, as to be described later. In the embodiment, the gate opening 95 is directly coupled to a cavity 99 of the mold 90.

The injection portion 23 includes a body portion 210, an injection nozzle portion 220, an injection heater 230, a heat insulating portion 240, a temperature detection unit 250, and a wiring portion 260. In the embodiment, the injection nozzle portion 220 is also referred to as a first nozzle portion, and the injection heater 230 is also referred to as a first heater.

The body portion 210 has a substantially cylindrical external shape. The body portion 210 is formed with a female thread, which is not shown, on an inner peripheral surface of an end portion thereof on a gate opening 95 side.

The body portion 210 is formed with an in-injection-portion flow path 270 along the axis AX. The in-injection-portion flow path 270 communicates with the communication hole 131. That is, the in-injection-portion flow path 270 communicates with the plasticizing unit 21. The plasticized material pumped from the suction and feed unit 22 flows through the in-injection-portion flow path 270. In the embodiment, the in-injection-portion flow path 270 is also referred to as a first flow path.

The injection nozzle portion 220 communicates with the in-injection-portion flow path 270 and injects the plasticized material. The injection nozzle portion 220 is fixed at an end portion of the injection portion 23 on the gate opening 95 side. The injection nozzle portion 220 includes a coupling portion 221, a flange portion 222, and a tip end portion 223. The coupling portion 221 is located on the plasticizing unit 21 side of the injection nozzle portion 220 and has a substantially cylindrical external shape. The coupling portion 221 is formed with a male thread, which is not shown, on an outer peripheral surface thereof. The male thread is screwed to the female thread formed in the body portion 210, and thereby the injection nozzle portion 220 is fixed to the body portion 210. The flange portion 222 has an outer diameter larger than an outer diameter of the coupling portion 221 and is continuous with the coupling portion 221. The flange portion 222 has an end surface on the plasticizing unit 21 side being in contact with an end surface of the body portion 210 on the gate opening 95 side. The tip end portion 223 is continuous with the flange portion 222 and has a substantially conical external shape that protrudes to the gate opening 95 side.

The injection nozzle portion 220 is formed with, inside thereof, an in-nozzle-portion flow path 225 along the axis AX, which communicates with the in-injection-portion flow path 270. In the embodiment, the communication hole 131, the in-injection-portion flow path 270, and the in-nozzle-portion flow path 225 are also collectively referred to as flow paths. The in-nozzle-portion flow path 225 has a function of guiding the plasticized material to the gate opening 95. The in-nozzle-portion flow path 225 is branched at a nozzle opening 224 formed in the tip end portion 223 of the injection nozzle portion 220. The nozzle opening 224 faces the end portion 94 of the hot runner attachment hole 93. In the embodiment, two nozzle openings 224 arranged side by side at equal intervals in a circumferential direction are formed in the tip end portion 223, but the number of nozzle openings 224 is not limited to two, and any number of nozzle openings 224 such as four may be formed. With such a structure, the in-nozzle-portion flow path 225 has a ring shape centered on the tip end portion 223 when viewed along the axis AX between the tip end portion 223 and the end portion 94. For this reason, the gate opening 95 has an open gate structure that is also referred to as a ring gate.

The body portion 210 is made of aluminum. The injection nozzle portion 220 is made of SUS303. The body portion 210 and the injection nozzle portion 220 are preferably formed of a material having high thermal conductivity. The body portion 210 may be formed of a metal material other than aluminum. The injection nozzle portion 220 may be formed of stainless steel other than SUS303, and may be formed of a metal material other than stainless steel such as aluminum.

The injection heater 230 heats the plasticized material in the in-injection-portion flow path 270. The injection heater 230 includes a coil heater embedded in the body portion 210. The injection heater 230 is disposed around the body portion 210 to surround the body portion 210. A temperature of the injection heater 230 is controlled by a first temperature control unit to be described later. By such heating, the plasticized material flowing through the in-injection-portion flow path 270 is maintained in a molten state. The injection heater 230 is not limited to a coil heater, and may be any heater such as a band heater.

The heat insulating portion 240 is located in a gap closer to the plasticizing unit than to the end portion 94 among gaps between the body portion 210, as well as the injection nozzle portion 220, and the hot runner attachment hole 93. The heat insulating portion 240 prevents heat of the injection portion 23 from transferring to the fixed mold 91. In the embodiment, the heat insulating portion 240 is formed of the same resin material as the plasticized material, and alternatively, the heat insulating portion 240 may be formed of any material having a relatively small thermal conductivity, and may also be implemented by a space.

The temperature detection unit 250 is embedded in the body portion 210. The temperature detection unit 250 detects a temperature of the injection heater 230. The temperature detection unit 250 is, for example, a thermocouple.

The wiring portion 260 is coupled to a side surface of the body portion 210 which is located closer to the plasticizing unit 21 than to the injection heater 230. The wiring portion 260 is a cylindrical member. The wiring portion 260 accommodates therein a wiring used for controlling the injection heater 230, a wiring used for controlling the temperature detection unit 250, and a wiring for supplying a current to the injection nozzle portion 220.

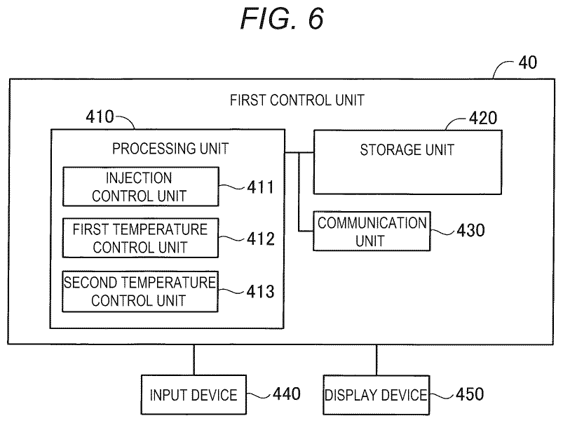

FIG. 6 shows a schematic configuration of the first control unit 40. The first control unit 40 is implemented by a computer that includes a processing unit 410, a storage unit 420, and a communication unit 430. The processing unit 410 includes one or a plurality of processors. The processing unit 410 controls operations of units of the injection molding device 10 by executing programs stored in the storage unit 420. The storage unit 420 includes a main storage device such as RAM and an auxiliary storage device such as a hard disk drive. The first control unit 40 may be implemented by, instead of a computer, a configuration in which a plurality of circuits for achieving at least a part of functions are combined. To the first control unit 40, an input device 440 such as a keyboard and a mouse and a display device 450 such as a liquid crystal display are coupled. The input device 440 and the display device 450 may be integrated as a touch panel. In the embodiment, the first control unit 40 is also referred to as a control unit.

The processing unit 410 includes an injection control unit 411, a first temperature control unit 412, and a second temperature control unit 413. The injection control unit 411, the first temperature control unit 412, and the second temperature control unit 413 are implemented by the processing unit 410 executing programs stored in the storage unit 420. These units may be implemented by circuits.

The injection control unit 411 controls units of the injection molding device 10 such as the drive motor 112, the barrel heater 140, the plunger drive unit 153, and the mold drive unit 171 to control the injection molding of the molded product.

The first temperature control unit 412 is electrically coupled to the injection heater 230 and controls the temperature of the injection heater 230. The first temperature control unit 412 controls the temperature of the injection heater 230 based on a set temperature of the injection heater 230 and a temperature detected by the temperature detection unit 250 such that the temperature of the injection heater 230 becomes the set temperature.

The second temperature control unit 413 is electrically coupled to the injection nozzle portion 220, and controls the temperature of the injection nozzle portion 220 by supplying a current to the injection nozzle portion 220. In the embodiment, a housing (not shown) that is coupled to the injection nozzle portion 220 via another member and accommodates the injection unit 20 therein is grounded. For this reason, when the current is supplied to the injection nozzle portion 220, the current flows through the injection nozzle portion 220, and the injection nozzle portion 220 generates heat. In the embodiment, the second temperature control unit 413 is electrically coupled to the injection nozzle portion 220 via the body portion 210. The second temperature control unit 413 may be directly electrically coupled to the injection nozzle portion 220 without the body portion 210.

The second temperature control unit 413 controls the current supplied to the injection nozzle portion 220 by executing pulse width modulation (PWM) control. The second temperature control unit 413 controls the temperature of the injection nozzle portion 220 by controlling a duty ratio in the PWM control. Specifically, the second temperature control unit 413 increases the temperature of the injection nozzle portion 220 by increasing the duty ratio, and decreases the temperature of the injection nozzle portion 220 by decreasing the duty ratio. The second temperature control unit 413 may control the current supplied to the injection nozzle portion 220 by executing control other than the PWM control.

The second temperature control unit 413 controls the temperature of the injection nozzle portion 220 by executing a plurality of controls including a first control and a second control. Here, the first control is control for supplying a current to the injection nozzle portion 220 such that the temperature of the injection nozzle portion 220 becomes a first temperature. The second control is control for supplying a current to the injection nozzle portion 220 such that the temperature of the injection nozzle portion 220 is a second temperature higher than the first temperature. In the embodiment, the second temperature control unit 413 makes the temperature of the injection nozzle portion 220 in the second control higher than the temperature of the injection nozzle portion 220 in the first control by making the duty ratio in the second control higher than the duty ratio in the first control. In the present specification, a state in which the first control is executed is also referred to as a preheating state, and a state in which the second control is executed is also referred to as a heating state.

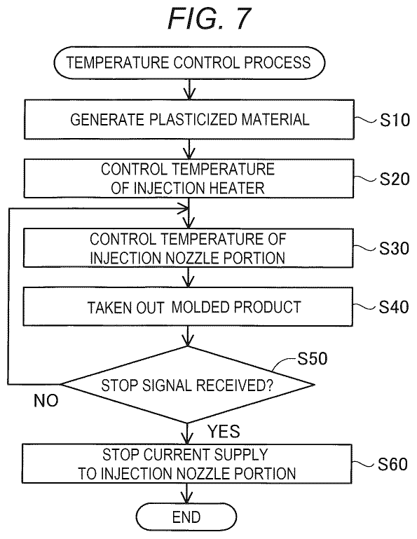

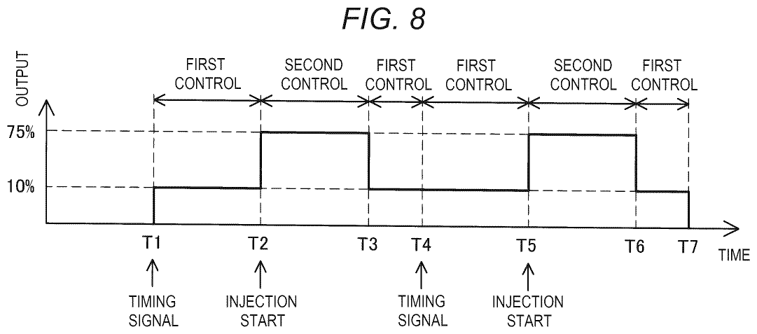

FIG. 7 is a flowchart of a temperature control process. The temperature control process is executed when the injection molding device 10 performs injection molding of a molded product. FIG. 8 is a time chart showing temperature control of the injection nozzle portion 220 by the second temperature control unit 413 in the temperature control process.

In step S10, the plasticizing unit 21 plasticizes the material and generates the plasticized material.

In step S20, the first temperature control unit 412 controls the temperature of the injection heater 230. Specifically, the first temperature control unit 412 controls the temperature of the injection heater 230 such that a temperature of the plasticized material in the in-injection-portion flow path 270 exceeds a plasticizing temperature. Step S20 is also referred to as a first step.

In step S30, the second temperature control unit 413 controls the temperature of the injection nozzle portion 220. First, the second temperature control unit 413 executes the first control when receiving a timing signal from the injection control unit 411. Here, the timing signal is a signal transmitted from the injection control unit 411 when mold clamping of the mold 90 is started. In the time chart shown in FIG. 8, the second temperature control unit 413 receives the timing signal at time T1 and executes the first control. The second temperature control unit 413 supplies a current to the injection nozzle portion 220 with, for example, a duty ratio of 10%. The second temperature control unit 413 counts time elapsing from a time point when the timing signal is received. The second temperature control unit 413 executes the second control when the elapsing time exceeds a first time that is a predetermined time. Here, the first time is a time from a time point when the mold clamping is started to a time point when the plunger 152 starts moving to pump the plasticized material in the injection cylinder 151 to the injection portion 23. The first time is stored in advance in the storage unit 420. The first time is, for example, substantially 3 seconds to 5 seconds. That is, the second temperature control unit 413 executes the first control before the plasticized material is injected from the injection nozzle portion 220. In the time chart shown in FIG. 8, at time T2, the first time elapses from the time point when the timing signal is received.

The second temperature control unit 413 executes the second control at time T2. The second temperature control unit 413 supplies a current to the injection nozzle portion 220 with, for example, a duty ratio of 75%. The second temperature control unit 413 preferably supplies a current to the injection nozzle portion 220 such that the temperature of the injection nozzle portion 220 becomes a temperature comparable to the temperature of the injection heater 230. The second temperature control unit 413 counts time elapsing from a time point of a start of the second control. The second temperature control unit 413 executes the first control when the elapsing time exceeds a second time that is a predetermined time. Here, the second time is a time from the time point when the plunger 152 starts moving to pump the plasticized material in the injection cylinder 151 to the injection portion 23 to a time point when the injection of the plasticized material from the injection nozzle portion 220 is completed. The second time is stored in the storage unit 420 in advance. The second time is, for example, substantially 0.1 seconds to 1 second. That is, the second temperature control unit 413 executes the second control when the plasticized material is injected from the injection nozzle portion 220. In the time chart shown in FIG. 8, at time T3, the second time elapses from the time point when the second control is started.

The second temperature control unit 413 executes the first control at time T3. The second temperature control unit 413 supplies a current to the injection nozzle portion 220 with, for example, a duty ratio of 10%. That is, the second temperature control unit 413 executes the first control after the plasticized material is injected from the injection nozzle portion 220. As described above, in step S30, the plasticized material is injected into the mold 90. Step S30 is also referred to as a second step.

In step S40, the injection control unit 411 controls the mold clamping unit 30 to open the mold 90. The molded product is taken out from the mold 90 by being pushed out by an ejector pin.

In step S50, the second temperature control unit 413 determines whether a stop signal is received from the injection control unit 411. When the stop signal is received, step S60 is executed. When no stop signal is received, the process returns to step S30. The stop signal is transmitted from the injection control unit 411, for example, when all cycles of the injection molding are completed.

When the process returns to step S30, the injection molding of the molded product is performed again. FIG. 8 shows a case where the process returns to step S30 and the second temperature control unit 413 receives the timing signal at time T4. In the example shown in FIG. 8, the second temperature control unit 413 executes the first control from time T4 to time T5, executes the second control from time T5 to time T6, and executes the first control from time T6 to time T7.

In step S60, the second temperature control unit 413 stops the supply of the current to the injection nozzle portion 220. Specifically, the second temperature control unit 413 sets the duty ratio to 0%. In the time chart shown in FIG. 8, the second temperature control unit 413 stops the supply of the current to the injection nozzle portion 220 at time T7. The injection control unit 411 controls units of the injection molding device 10 to stop the injection molding of the molded product. The temperature control process is executed as described above.

According to the first embodiment described above, the injection molding device 10 includes the injection portion 23 that includes the injection nozzle portion 220 made of a metal material, and the second temperature control unit 413 is electrically coupled to the injection nozzle portion 220 and controls the temperature of the injection nozzle portion 220 by supplying a current to the injection nozzle portion 220. In other words, the injection molding device 10 includes the first hot runner that includes the first nozzle portion made of a metal material, and the second temperature control unit 413 is electrically coupled to the first nozzle portion and controls the temperature of the first nozzle portion by supplying a current to the first nozzle portion. For this reason, the first nozzle portion can be heated even when no heater is disposed around the first nozzle portion. Therefore, fluidity of the plasticized material during injection can be improved.

Further, in the embodiment, the second temperature control unit 413 controls the temperature of the injection nozzle portion 220 by executing a plurality of controls including the first control of supplying the current to the injection nozzle portion 220 such that the temperature of the injection nozzle portion 220 becomes the first temperature and the second control of supplying the current to the injection nozzle portion 220 such that the temperature of the injection nozzle portion 220 becomes the second temperature higher than the first temperature. In other words, the second temperature control unit 413 controls the temperature of the first nozzle portion by executing a plurality of controls including the first control of supplying a current to the first nozzle portion such that the temperature of the first nozzle portion becomes the first temperature and the second control of supplying a current to the first nozzle portion such that the temperature of the first nozzle portion becomes the second temperature higher than the first temperature. For this reason, the temperature of the first nozzle portion can be controlled according to the plasticizing temperature of the material. Accordingly, even when the material used for injection molding is changed, the fluidity of the plasticized material during injection can be improved.

In the embodiment, the second temperature control unit 413 executes the first control before the plasticized material is injected from the injection nozzle portion 220, and executes the second control when the plasticized material is injected from the injection nozzle portion 220. In other words, the second temperature control unit 413 executes the first control before the plasticized material is injected from the first nozzle portion, and executes the second control when the plasticized material is injected from the first nozzle portion. For this reason, before the plasticized material is injected, the temperature of the first nozzle portion can be maintained at a temperature at which the plasticized material can maintain fluidity, and the temperature of the first nozzle portion can be further increased when the plasticized material is injected. Engineering plastics such as polyetheretherketone (PEEK) and polyimide change in material characteristics when being continuously heated at a high temperature. In the embodiment, when a material such as the above-described engineering plastics is used for injection molding, a change in material characteristics can be prevented.

In the embodiment, the second temperature control unit 413 executes the first control after the plasticized material is injected from the injection nozzle portion 220. In other words, the second temperature control unit 413 executes the first control after the plasticized material is injected from the first nozzle portion. For this reason, the temperature of the first nozzle portion can be maintained at the first temperature after the plasticized material is injected. Therefore, when the injection molding is repeatedly performed, heating time of the first nozzle portion can be shortened, and an injection molding cycle can be shortened.

### B. Second Embodiment

The second embodiment is different from the first embodiment in contents of the temperature control process. Configurations of the injection molding device 10 in the second embodiment are the same as those in the first embodiment.

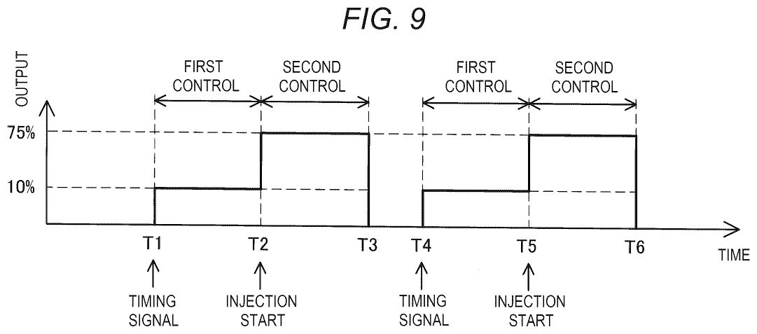

FIG. 9 is a time chart showing the temperature control of the injection nozzle portion 220 by the second temperature control unit 413 according to the second embodiment. In the second embodiment, in step S30 of the temperature control process shown in FIG. 7, the second temperature control unit 413 stops the supply of the current to the injection nozzle portion 220 after the plasticized material is injected from the injection nozzle portion 220. Specifically, the second temperature control unit 413 stops the supply of the current to the injection nozzle portion 220 when the second time elapses from the time point of the start of the second control. In the example shown in FIG. 9, the second temperature control unit 413 stops the supply of the current to the injection nozzle portion 220 at time T3 and time T6. In the second embodiment, since the supply of the current to the injection nozzle portion 220 is stopped in step S30, step S60 in FIG. 7 is not executed.

According to the second embodiment described above, the second temperature control unit 413 stops the supply of the current to the injection nozzle portion 220 after the plasticized material is injected from the injection nozzle portion 220. In other words, the second temperature control unit 413 stops the supply of the current to the first nozzle portion after the plasticized material is injected from the first nozzle portion. For this reason, the temperature of the first nozzle portion decreases after the injection of the plasticized material. Accordingly, the molded product can be easily cured.

### C. Third Embodiment

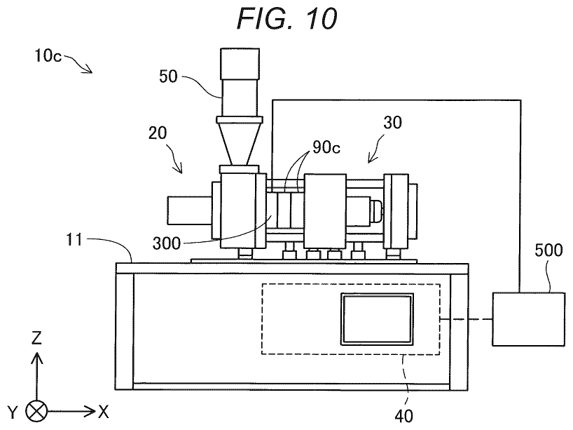

FIG. 10 shows a schematic configuration of an injection molding device 10c according to the third embodiment. The injection molding device 10c further includes a hot runner unit 300 and a hot runner control unit 500. The hot runner control unit 500 is communicably connected to the hot runner unit 300 and the first control unit 40 by a communication line. In the third embodiment, the first control unit 40 and the hot runner control unit 500 are also collectively referred to as a control unit.

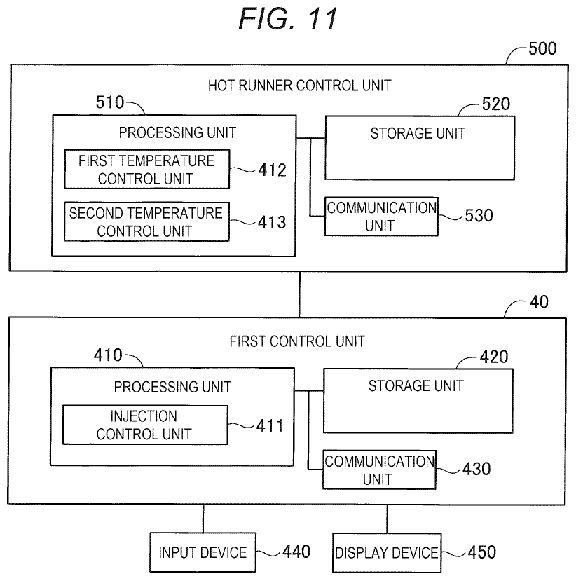

FIG. 11 shows schematic configurations of the hot runner control unit 500 and the first control unit 40. The hot runner control unit 500 includes a processing unit 510, a storage unit 520, and a communication unit 530. The processing unit 510 includes one or a plurality of processors. The storage unit 520 includes a storage device such as RAM and ROM. The communication unit 530 is an interface for communicating with the hot runner unit 300 and the first control unit 40.

The processing unit 510 includes the first temperature control unit 412 and the second temperature control unit 413. The first temperature control unit 412 and the second temperature control unit 413 are implemented by the processing unit 510 executing programs stored in the storage unit 520. These units may be implemented by circuits. In the third embodiment, the processing unit 410 of the first control unit 40 includes the injection control unit 411 and does not include the first temperature control unit 412 or the second temperature control unit 413.

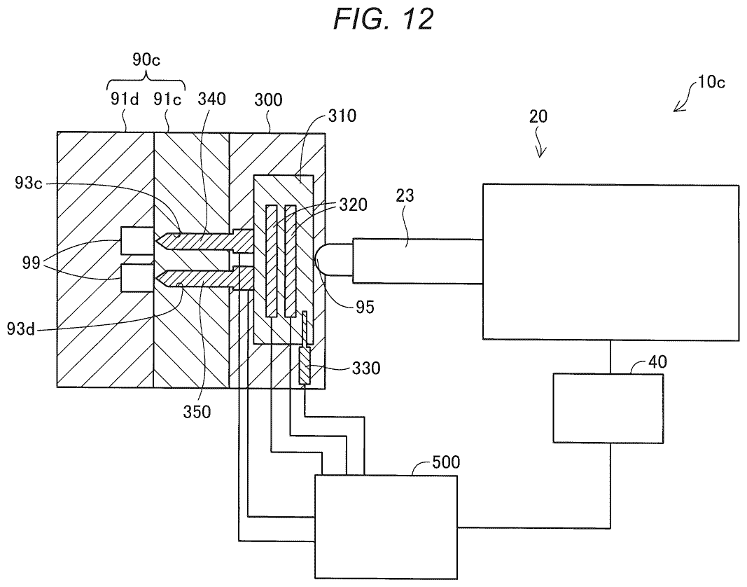

FIG. 12 shows a schematic configuration of the injection molding device 10c according to the third embodiment. In FIG. 12, illustration of the mold clamping unit 30 is omitted. Configurations of components of the injection unit 20 and the mold clamping unit 30 in the third embodiment are the same as those in the first embodiment.

Structures of the hot runner unit 300 and a mold 90c according to the third embodiment will be described with reference to FIG. 12. The hot runner unit 300 is disposed between the injection portion 23 and a fixed mold 91c. The hot runner unit 300 includes a manifold 310, a manifold heater 320, a manifold temperature detection unit 330, a first injection portion 340, and a second injection portion 350.

The manifold 310 is formed with a manifold flow path (not shown) therein. A starting end of the manifold flow path is coupled to the gate opening 95 of the injection portion 23. The manifold flow path branches into two flow paths in the manifold 310. Each of the branch flow paths is coupled to a first flow path to be described later provided in the first injection portion 340 and a second flow path to be described later provided in the second injection portion 350. The plasticized material in the manifold flow path is heated by the manifold heater 320 inserted into the manifold 310. The manifold heater 320 heats the manifold 310, so that the plasticized material in the manifold flow path is maintained in a molten state. The temperature of the manifold heater 320 is controlled by the hot runner control unit 500. The manifold temperature detection unit 330 is inserted into the manifold 310 and detects the temperature of the manifold 310. The manifold temperature detection unit 330 is, for example, a thermocouple.

In the third embodiment, the fixed mold 91c is formed with two hot runner attachment holes 93 penetrating the fixed mold 91c in the X direction. Hereinafter, one of the hot runner attachment holes 93 is referred to as a first hot runner attachment hole 93c, and the other hot runner attachment hole 93 is referred to as a second hot runner attachment hole 93d. The first injection portion 340 is disposed in the first hot runner attachment hole 93c, and the second injection portion 350 is disposed in the second hot runner attachment hole 93d.

Configurations of components of the first injection portion 340 and the second injection portion 350 are the same as those of the injection portion 23 of the injection unit 20. In the third embodiment, the first injection portion 340 is referred to as a first hot runner, and the second injection portion 350 is referred to as a second hot runner. In the third embodiment, a member of the first injection portion 340 which corresponds to the injection nozzle portion 220 of the injection portion 23 is referred to as a first nozzle portion, a member of the first injection portion 340 which corresponds to the injection heater 230 of the injection portion 23 is referred to as a first heater, and a member of the first injection portion 340 which corresponds to the in-injection-portion flow path 270 of the injection portion 23 is referred to as a first flow path. In the third embodiment, a member of the second injection portion 350 which corresponds to the injection nozzle portion 220 of the injection portion 23 is referred to as a second nozzle portion, a member of the second injection portion 350 which corresponds to the injection heater 230 of the injection portion 23 is referred to as a second heater, and a member of the second injection portion 350 which corresponds to the in-injection-portion flow path 270 of the injection portion 23 is referred to as a second flow path. In the third embodiment, the communication hole 131, the in-injection-portion flow path 270, the in-nozzle-portion flow path 225, the manifold flow path, the first flow path, and the second flow path are collectively referred to as flow paths. The first flow path and the second flow path communicate with the plasticizing unit 21, and the plasticized material injected from the injection portion 23 flows therein.

Two cavities 99 are formed between the fixed mold 91c and a movable mold 92c. The first injection portion 340 and the second injection portion 350 inject the plasticized material into different cavities 99.

In the third embodiment, the injection control unit 411 controls the temperature of the injection heater 230 of the injection portion 23 and further controls the temperature of the injection nozzle portion 220 of the injection portion 23 by supplying a current to the injection nozzle portion 220. The injection control unit 411 controls the temperature of the injection heater 230 and the temperature of the injection nozzle portion 220 such that the plasticized material in the in-injection-portion flow path 270 and the in-nozzle-portion flow path 225 is maintained in a molten state.

The first temperature control unit 412 is electrically coupled to the first heater and controls the temperature of the first heater. The first temperature control unit 412 controls the temperature of the first heater based on a set temperature of the first heater and the temperature detected by the temperature detection unit provided in the first injection portion 340 such that the temperature of the first heater becomes the set temperature. The first temperature control unit 412 is electrically coupled to the second heater and controls the temperature of the second heater. The first temperature control unit 412 controls the temperature of the second heater based on a set temperature of the second heater and the temperature detected by the temperature detection unit provided in the second injection portion 350 such that the temperature of the second heater becomes the set temperature.

The second temperature control unit 413 is electrically coupled to the first nozzle portion, and controls the temperature of the first nozzle portion by supplying a current to the first nozzle portion. The second temperature control unit 413 is electrically coupled to the second nozzle portion and controls the temperature of the second nozzle portion by supplying a current to the second nozzle portion. Specifically, the second temperature control unit 413 controls the currents supplied to the first nozzle portion and the second nozzle portion by individually executing the PWM control on the first nozzle portion and the second nozzle portion. The second temperature control unit 413 individually controls the temperature of the first nozzle portion and the temperature of the second nozzle portion by individually supplying currents to the first nozzle portion and the second nozzle portion.

The second temperature control unit 413 controls the temperature of the first nozzle portion by executing a plurality of controls including a first control and a second control. In the embodiment, the first control is control for supplying a current to the first nozzle portion such that the temperature of the first nozzle portion becomes a first temperature. The second control is control for supplying a current to the first nozzle portion such that the temperature of the first nozzle portion becomes a second temperature higher than the first temperature. The second temperature control unit 413 controls the temperature of the second nozzle portion by executing a plurality of controls including a third control and a fourth control. The third control is control for supplying a current to the second nozzle portion such that the temperature of the second nozzle portion becomes a third temperature. The fourth control is control for supplying a current to the second nozzle portion such that the temperature of the second nozzle portion becomes a fourth temperature higher than the third temperature. The second temperature control unit 413 makes the temperature of the second nozzle portion in the fourth control higher than the temperature of the second nozzle portion in the third control by making a duty ratio in the fourth control higher than a duty ratio in the third control. In the present specification, a state in which the third control is executed is also referred to as a preheating state, and a state in which the fourth control is executed is also referred to as a heating state. In the embodiment, the third temperature is different from the first temperature, and the fourth temperature is different from the second temperature. That is, the second temperature control unit 413 controls the temperature of the first nozzle portion and the temperature of the second nozzle portion such that the temperature of the first nozzle portion is different from the temperature of the second nozzle portion. The third temperature and the first temperature may be equal. The fourth temperature and the second temperature may be equal.

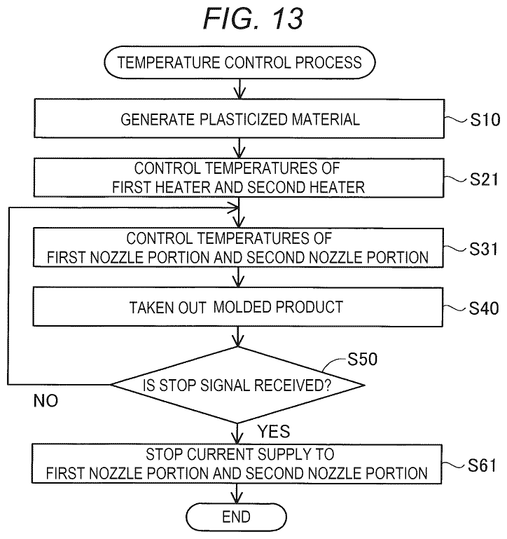

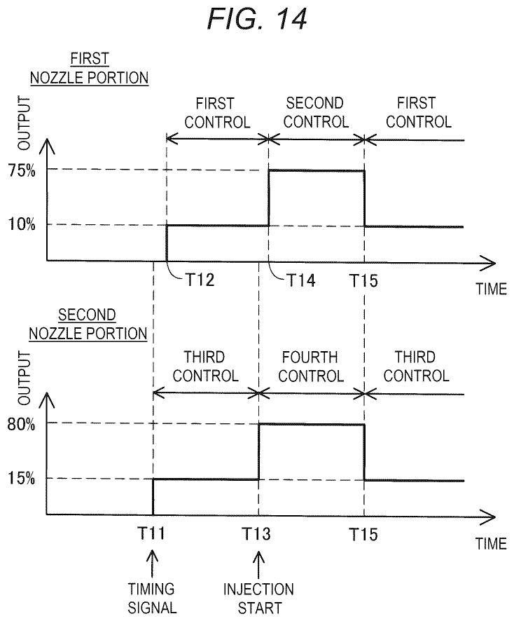

FIG. 13 is a flowchart of a temperature control process according to the third embodiment. For a part in which processing similar to that in the temperature control process in the first embodiment is executed, the same reference numerals are given and description thereof will be omitted. FIG. 14 is a time chart showing temperature control of the first nozzle portion and the second nozzle portion by the second temperature control unit 413 according to the third embodiment.

In step S21, the first temperature control unit 412 controls the temperatures of the first heater and the second heater. Specifically, the first temperature control unit 412 controls the temperatures of the first heater and the second heater such that the temperature of the plasticized material in the first flow path and the second flow path exceeds the plasticizing temperature.

In step S31, the second temperature control unit 413 controls the temperatures of the first nozzle portion and the second nozzle portion. First, the second temperature control unit 413 executes the first control and the third control when receiving a timing signal from the injection control unit 411. The second temperature control unit 413 executes control such that a start timing of the first control in the first nozzle portion is different from a start timing of the third control in the second nozzle portion. In the time chart shown in FIG. 14, the second temperature control unit 413 receives the timing signal at time T11. The second temperature control unit 413 starts the third control at time T11. The second temperature control unit 413 starts the first control at time T12 when a predetermined time elapses from time T11. The predetermined time is a value determined according to a difference in temperature characteristics between the first injection portion 340 and the second injection portion 350 and a difference in length of the manifold flow path between the gate opening 95 and each of the injection portions 340 and 350, and is stored in the storage unit 520 in advance.

The second temperature control unit 413 executes the second control and the fourth control when a first time elapses from a time point at which the timing signal is received. The second temperature control unit 413 executes control such that a start timing of the second control in the first nozzle portion is different from a start timing of the fourth control in the second nozzle portion. In the time chart shown in FIG. 14, at time T13, the first time elapses from the time point when the timing signal is received. The second temperature control unit 413 starts the fourth control at time T13. The second temperature control unit 413 starts the second control at time T14 when a predetermined time elapses from time T13. The predetermined time is a value determined according to a difference in temperature characteristics between the first injection portion 340 and the second injection portion 350 and a difference in length of the manifold flow path between the gate opening 95 and each of the injection portions 340 and 350, and is stored in the storage unit 520 in advance.

The second temperature control unit 413 executes the first control and the third control when a time obtained by adding the first time and the second time elapses from the time point when the timing signal is received. In the time chart shown in FIG. 14, at time T15, a time obtained by adding the first time and the second time elapses from the time point when the timing signal is received. The second temperature control unit 413 starts the first control and the third control at time T15.

In step S61, the second temperature control unit 413 stops the supply of the currents to the first nozzle portion and the second nozzle portion.

According to the third embodiment described above, the injection molding device 10c includes the first hot runner that includes the first nozzle portion made of a metal material and the second hot runner that includes the second nozzle portion made of a metal material, and the second temperature control unit 413 is electrically coupled to the first nozzle portion and the second nozzle portion and individually controls the temperature of the first nozzle portion and the temperature of the second nozzle portion by individually supplying currents to the first nozzle portion and the second nozzle portion. For this reason, the temperature of the first nozzle portion and the temperature of the second nozzle portion can be controlled according to a difference in temperature characteristics between the first hot runner and the second hot runner, a difference in flow path length from the plasticizing unit 21 to each of the first and second hot runners, and the like.

In the embodiment, the second temperature control unit 413 controls the temperature of the first nozzle portion and the temperature of the second nozzle portion such that the temperature of the first nozzle portion is different from the temperature of the second nozzle portion. For this reason, the temperature of the first nozzle portion and the temperature of the second nozzle portion can be controlled according to a difference in temperature characteristics between the first hot runner and the second hot runner, a difference in flow path length from the plasticizing unit 21 to each of the first and second hot runners, and the like. For example, when the flow path length from the plasticizing unit 21 to the first hot runner is larger than the flow path length from the plasticizing unit 21 to the second hot runner, the temperature of the plasticized material in the first hot runner tends to be lower than the temperature of the plasticized material in the second hot runner. In such a case, by setting the temperature of the first nozzle portion to be higher than the temperature of the second nozzle portion, the temperature of the plasticized material in the first hot runner and the temperature of the plasticized material in the second hot runner can be made substantially the same.

In the embodiment, the second temperature control unit 413 controls the temperature of the second nozzle portion by executing a plurality of controls including the third control of supplying a current to the second nozzle portion such that the temperature of the second nozzle portion becomes the third temperature and the fourth control of supplying a current to the second nozzle portion such that the temperature of the second nozzle portion becomes the fourth temperature higher than the third temperature, and executes control such that the start timing of the first control in the first nozzle portion is different from the start timing of the third control in the second nozzle portion, or the start timing of the second control in the first nozzle portion is different from the start timing of the fourth control in the second nozzle portion. For this reason, the temperature of the first nozzle portion and the temperature of the second nozzle portion can be controlled according to a difference in temperature characteristics between the first hot runner and the second hot runner, a difference in flow path length from the plasticizing unit 21 to each of the first and second hot runners, and the like.

### D. Other Embodiments

(D-1) In the above embodiments, the second temperature control unit 413 executes the second control when the first time elapses from the time point at which the timing signal is received. In contrast, the second temperature control unit 413 may continue to execute the first control from the time point when the timing signal is received to a time point when a stop signal is received.

(D-2) In the above embodiments, the hot runner unit 300 includes two hot runners including the first hot runner and the second hot runner. In contrast, the hot runner unit 300 may include three or more hot runners.

(D-3) In the above embodiments, the second temperature control unit 413 controls the temperature of the first nozzle portion by executing a plurality of controls including the first control and the second control. In contrast, the second temperature control unit 413 may not execute the first control or the second control.

(D-4) In the above embodiments, the second temperature control unit 413 executes the first control before the plasticized material is injected from the first nozzle portion, and executes the second control when the plasticized material is injected from the first nozzle portion. In contrast, the second temperature control unit 413 may not execute the first control before the plasticized material is injected from the first nozzle portion. The second temperature control unit 413 may not execute the second control when the plasticized material is injected from the first nozzle portion.

(D-5) In the above embodiments, the second temperature control unit 413 executes the first control after the plasticized material is injected from the first nozzle portion. In contrast, the second temperature control unit 413 may not execute the first control after the plasticized material is injected from the first nozzle portion.

(D-6) In the above embodiments, the second temperature control unit 413 controls the temperature of the first nozzle portion and the temperature of the second nozzle portion such that the temperature of the first nozzle portion is different from the temperature of the second nozzle portion. In contrast, the second temperature control unit 413 may control the temperature of the first nozzle portion and the temperature of the second nozzle portion such that the temperature of the first nozzle portion is equal to the temperature of the second nozzle portion.

(D-7) In the above embodiments, the second temperature control unit 413 executes control such that the start timing of the first control in the first nozzle portion is different from the start timing of the third control in the second nozzle portion, and the start timing of the second control in the first nozzle portion is different from the start timing of the fourth control in the second nozzle portion. In contrast, the second temperature control unit 413 may execute control such that at least one of the start timing of the first control in the first nozzle portion and the start timing of the third control in the second nozzle portion, and the start timing of the second control in the first nozzle portion and the start timing of the fourth control in the second nozzle portion are at the same time.

(D-8) In the above embodiments, the second temperature control unit 413 controls the temperature of the second nozzle portion by executing a plurality of controls including the third control and the fourth control. In contrast, the second temperature control unit 413 may not execute the third control or the fourth control.

(D-9) In the third embodiment, the second temperature control unit 413 executes control such that the start timing of the first control in the first nozzle portion is later than the start timing of the third control in the second nozzle portion. In contrast, the second temperature control unit 413 may execute control such that the start timing of the first control in the first nozzle portion is earlier than the start timing of the third control in the second nozzle portion.

(D-10) In the third embodiment, the second temperature control unit 413 executes control such that the start timing of the second control in the first nozzle portion is later than the start timing of the fourth control in the second nozzle portion. In contrast, the second temperature control unit 413 may execute control such that the start timing of the second control in the first nozzle portion is earlier than the start timing of the fourth control in the second nozzle portion.

### E. Other Aspects

The present disclosure is not limited to the embodiments described above, and can be implemented in various aspects without departing from the spirit of the present disclosure. For example, the present disclosure may also be implemented in following aspects. To solve a part or all of the problems of the present disclosure, or to achieve a part or all of the advantages of the present disclosure, the technical features in the above embodiments corresponding to technical features in the following aspects can be replaced or combined as appropriate. The technical features can be deleted as appropriate unless described as necessary features in the present specification.

(1) According to a first aspect of the present disclosure, an injection molding device is provided. The injection molding device injects a plasticized material into a mold and performs injection molding of a molded product, the injection molding device including: a plasticizing unit configured to plasticize a material and generate the plasticized material; a first hot runner including a first flow path that communicates with the plasticizing unit and through which the plasticized material flows, a first nozzle portion that communicates with the first flow path and injects the plasticized material, and a first heater that heats the plasticized material in the first flow path; and a control unit configured to control injection of the plasticized material, in which the first nozzle portion is made of a metal material, and the control unit includes a first temperature control unit that is electrically coupled to the first heater and controls a temperature of the first heater and a second temperature control unit that is electrically coupled to the first nozzle portion and controls a temperature of the first nozzle portion by supplying a current to the first nozzle portion.

According to such an aspect, the first nozzle portion can be heated even when no heater is disposed around the first nozzle portion. Therefore, fluidity of the plasticized material during injection can be improved.

(2) In the above aspect, the second temperature control unit may control the temperature of the first nozzle portion by executing a plurality of controls including a first control of supplying a current to the first nozzle portion such that the temperature of the first nozzle portion becomes a first temperature and a second control of supplying a current to the first nozzle portion such that the temperature of the first nozzle portion becomes a second temperature higher than the first temperature.

According to such an aspect, the temperature of the first nozzle portion can be controlled according to the plasticizing temperature of the material. Accordingly, even when the material used for injection molding is changed, the fluidity of the plasticized material during injection can be improved.

(3) In the above aspect, the second temperature control unit may execute the first control before the plasticized material is injected from the first nozzle portion and execute the second control when the plasticized material is injected from the first nozzle portion.

According to such an aspect, before the plasticized material is injected, the temperature of the first nozzle portion can be maintained at a temperature at which the plasticized material can maintain fluidity, and the temperature of the first nozzle portion can be further increased when the plasticized material is injected.

(4) In the above aspect, the second temperature control unit may execute the first control after the plasticized material is injected from the first nozzle portion.

According to such an aspect, the temperature of the first nozzle portion can be maintained at the first temperature after the plasticized material is injected. Therefore, when the injection molding is repeatedly performed, heating time of the first nozzle portion can be shortened, and an injection molding cycle can be shortened.

(5) In the above aspect, the second temperature control unit may stop the supply of the current to the first nozzle portion after the plasticized material is injected from the first nozzle portion.

According to such an aspect, the temperature of the first nozzle portion decreases after the injection of the plasticized material. Accordingly, the molded product can be easily cured.

(6) In the above aspect, the injection molding device may further include a second hot runner including a second flow path that communicates with the plasticizing unit and through which the plasticized material flows, a second nozzle portion that communicates with the second flow path and injects the plasticized material, and a second heater that heats the plasticized material in the second flow path, the second nozzle portion may be made of a metal material, the first temperature control unit may be electrically coupled to the second heater and control a temperature of the second heater, and the second temperature control unit may be electrically coupled to the second nozzle portion, control a temperature of the second nozzle portion by supplying a current to the second nozzle portion, and individually control the temperature of the first nozzle portion and the temperature of the second nozzle portion by individually supplying currents to the first nozzle portion and the second nozzle portion.

According to such an aspect, the temperature of the first nozzle portion and the temperature of the second nozzle portion can be controlled according to a difference in temperature characteristics between the first hot runner and the second hot runner, a difference in flow path length from the plasticizing unit to each of the first and second hot runners, and the like.

(7) In the above aspect, the second temperature control unit may control the temperature of the first nozzle portion and the temperature of the second nozzle portion such that the temperature of the first nozzle portion is different from the temperature of the second nozzle portion.

According to such an aspect, the temperature of the first nozzle portion and the temperature of the second nozzle portion can be controlled according to a difference in temperature characteristics between the first hot runner and the second hot runner, a difference in flow path length from the plasticizing unit to each of the first and second hot runners, and the like.

(8) In the above aspect, the second temperature control unit may control the temperature of the first nozzle portion by executing a plurality of controls including a first control of supplying a current to the first nozzle portion such that the temperature of the first nozzle portion becomes a first temperature and a second control of supplying a current to the first nozzle portion such that the temperature of the first nozzle portion becomes a second temperature higher than the first temperature, control the temperature of the second nozzle portion by executing a plurality of controls including a third control of supplying a current to the second nozzle portion such that the temperature of the second nozzle portion becomes a third temperature and a fourth control of supplying a current to the second nozzle portion such that the temperature of the second nozzle portion becomes a fourth temperature higher than the third temperature, and execute control such that a start timing of the first control in the first nozzle portion is different from a start timing of the third control in the second nozzle portion, or a start timing of the second control in the first nozzle portion is different from a start timing of the fourth control in the second nozzle portion.

According to such an aspect, the temperature of the first nozzle portion and the temperature of the second nozzle portion can be controlled according to a difference in temperature characteristics between the first hot runner and the second hot runner, a difference in flow path length from the plasticizing unit to each of the first and second hot runners, and the like.

(9) According to a second aspect of the present disclosure, an injection molding method is provided. The injection molding method performs injection molding of a molded product by an injection molding device, the injection molding device including a plasticizing unit configured to plasticize a material and generate a plasticized material and a first hot runner including a first flow path that communicates with the plasticizing unit and through which the plasticized material flows, a first nozzle portion that communicates with the first flow path and injects the plasticized material, and a first heater that heats the plasticized material in the first flow path, the first nozzle portion being made of a metal material, the injection molding method including: a first step of controlling a temperature of the first heater; and a second step of controlling a temperature of the first nozzle portion by supplying a current to the first nozzle portion.

According to such an aspect, the first nozzle portion can be heated even when no heater is disposed around the first nozzle portion. Therefore, fluidity of the plasticized material during injection can be improved.

What is claimed is:

1. An injection molding device that injects a plasticized material into a mold and performs injection molding of a molded product, the injection molding device comprising:
a plasticizing unit configured to plasticize a material and generate the plasticized material;
a first hot runner including a first flow path that communicates with the plasticizing unit and through which the plasticized material flows, a first nozzle portion that communicates with the first flow path and injects the plasticized material, and a first heater that heats the plasticized material in the first flow path; and
a control unit configured to control injection of the plasticized material, wherein
the first nozzle portion is made of a metal material, and
the control unit includes a first temperature control unit that is electrically coupled to the first heater and controls a temperature of the first heater and a second temperature control unit that is electrically coupled to the first nozzle portion and controls a temperature of the first nozzle portion by supplying a current to the first nozzle portion.

2. The injection molding device according to claim 1, wherein
the second temperature control unit controls the temperature of the first nozzle portion by executing a plurality of controls including
a first control of supplying a current to the first nozzle portion such that the temperature of the first nozzle portion becomes a first temperature and
a second control of supplying a current to the first nozzle portion such that the temperature of the first nozzle portion becomes a second temperature higher than the first temperature.

3. The injection molding device according to claim 2, wherein
the second temperature control unit executes the first control before the plasticized material is injected from the first nozzle portion, and
executes the second control when the plasticized material is injected from the first nozzle portion.

4. The injection molding device according to claim 3, wherein
the second temperature control unit executes the first control after the plasticized material is injected from the first nozzle portion.

5. The injection molding device according to claim 3, wherein
the second temperature control unit stops the supply of the current to the first nozzle portion after the plasticized material is injected from the first nozzle portion.

6. The injection molding device according to claim 1, further comprising:
a second hot runner including a second flow path that communicates with the plasticizing unit and through which the plasticized material flows, a second nozzle portion that communicates with the second flow path and injects the plasticized material, and a second heater that heats the plasticized material in the second flow path, wherein
the second nozzle portion is made of a metal material,
the first temperature control unit is electrically coupled to the second heater and controls a temperature of the second heater, and
the second temperature control unit is electrically coupled to the second nozzle portion, controls a temperature of the second nozzle portion by supplying a current to the second nozzle portion, and individually controls the temperature of the first nozzle portion and the temperature of the second nozzle portion by individually supplying currents to the first nozzle portion and the second nozzle portion.

7. The injection molding device according to claim 6, wherein
the second temperature control unit controls the temperature of the first nozzle portion and the temperature of the second nozzle portion such that the temperature of the first nozzle portion is different from the temperature of the second nozzle portion.

8. The injection molding device according to claim 6, wherein
the second temperature control unit controls the temperature of the first nozzle portion by executing a plurality of controls including
a first control of supplying a current to the first nozzle portion such that the temperature of the first nozzle portion becomes a first temperature and
a second control of supplying a current to the first nozzle portion such that the temperature of the first nozzle portion becomes a second temperature higher than the first temperature,
controls the temperature of the second nozzle portion by executing a plurality of controls including
a third control of supplying a current to the second nozzle portion such that the temperature of the second nozzle portion becomes a third temperature and
a fourth control of supplying a current to the second nozzle portion such that the temperature of the second nozzle portion becomes a fourth temperature higher than the third temperature, and
executes control such that a start timing of the first control in the first nozzle portion is different from a start timing of the third control in the second nozzle portion, or a start timing of the second control in the first nozzle portion is different from a start timing of the fourth control in the second nozzle portion.

9. An injection molding method for performing injection molding of a molded product by an injection molding device, the injection molding device including
a plasticizing unit configured to plasticize a material and generate a plasticized material and
a first hot runner including a first flow path that communicates with the plasticizing unit and through which the plasticized material flows, a first nozzle portion that communicates with the first flow path and injects the plasticized material, and a first heater that heats the plasticized material in the first flow path,
the first nozzle portion being made of a metal material,
the injection molding method comprising:
a first step of controlling a temperature of the first heater; and
a second step of controlling a temperature of the first nozzle portion by supplying a current to the first nozzle portion.
